(19) United States
(12) Patent Application Publication
(10) Pub. No.: US 2013/0143608 A1
(43) Pub. Date: Jun. 6, 2013

(54) MOBILE PHONE FOR PROCESSING SHORT MESSAGES AND METHOD THEREOF

(71) Applicant: XI LIN, Shenzhen (CN)

(72) Inventor: XI LIN, Shenzhen (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/340,698

(22) Filed: Dec. 30, 2011

(30) Foreign Application Priority Data
Dec. 6, 2011 (CN) 201110400887.X

(51) Int. Cl. H04W 4/14

(52) U.S. Cl. 455/466

(57) ABSTRACT

The present invention provides a mobile phone and a method for processing short messages adapted for the mobile phone. The mobile phone stores a first and a second groups of keywords, at least one folder, and a plurality of relationships between the at least one folder and the first group of keywords. When the mobile phone 1 receives a short message, the mobile phone 1 determines whether the short message is junk or useful according to the keywords predefined by the user. If the short message is junk, the mobile phone 1 directly deletes the short message. If the short message is determined to be useful or desirable, the mobile phone 1 stores the short message in a corresponding folder to later display. The processing of the desirable and useful messages only is rendered convenient for the user.

### BACKGROUND

1. Technical Field

The disclosure relates to mobile phones and, more particularly, to a mobile phone for processing short messages and a method for processing short messages adapted for the mobile phone.

2. Description of Related Art

A mobile phone may receive all kinds of short messages and the user of the mobile phone may not know everyone who sent the short messages. Some of the short messages are junk messages or about identity theft and some of the short messages are of interest to the user. However, the processing system of related art simply stores or deletes the short messages. If the mobile phone stores junk short messages, the junk short messages will occupy storage space of the mobile phone. If the mobile phone deletes the short messages which are of interest to the user, the user loses information in the short messages which may be valuable to or desired by the user.

Therefore, what is needed is a mobile phone for processing short messages to overcome the described shortcomings.

### BRIEF DESCRIPTION OF THE DRAWINGS

FIG. 1 is a block diagram of a mobile phone for processing short messages in accordance with an exemplary embodiment.

FIG. 2 is a block diagram of a control unit of the mobile phone of FIG. 1.

FIG. 3 is a flowchart of a method for processing short messages adapted for the mobile phone of FIG. 1.

### DETAILED DESCRIPTION

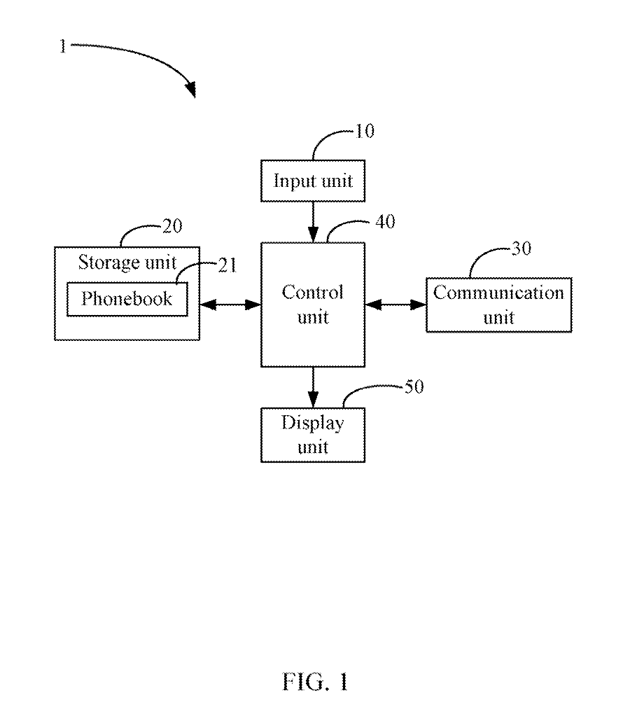

FIG. 1 is a block diagram of a mobile phone for processing short messages in accordance with an exemplary embodiment. The mobile phone for processing short messages (hereinafter “mobile phone”) 1 includes an input unit 10, a storage unit 20, a communication unit 30, a control unit 40, and a display unit 50. The input unit 10 generates input signals in response to user inputs. The communication unit 30 establishes a link with a wireless communication system (not shown) and receives short messages from the wireless communication system. The display unit 50 displays information.

The storage unit 20 stores data, such as a phonebook 21 and an inbox for short messages. The phonebook 21 stores a number of contacts. Each contact includes a name and at least one phone number.

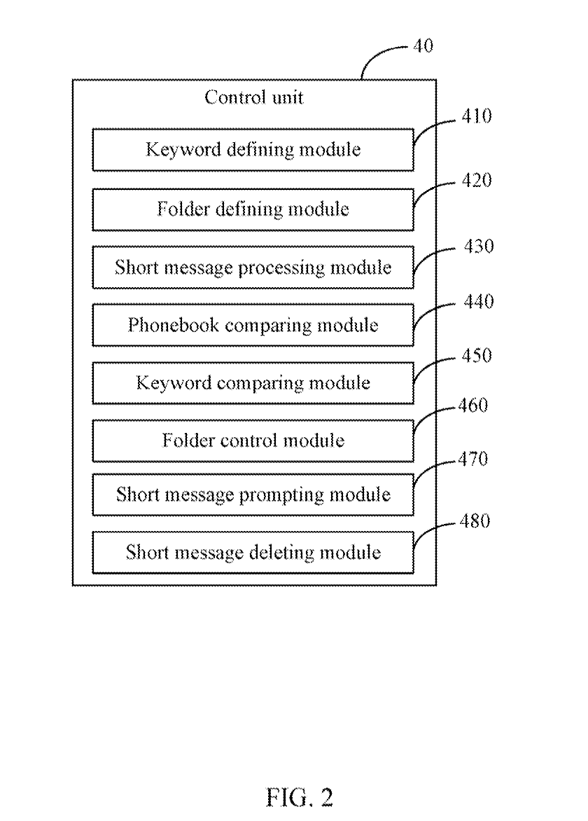

The control unit 40 controls the mobile phone 1. As shown in FIG. 2, the control unit 40 further includes a keyword defining module 410, a folder defining module 420, a short message processing module 430, a phonebook comparing module 440, a keyword comparing module 450, a folder control module 460, a short message prompting module 470, and a short message deleting module 480.

The keyword defining module 410 controls the display unit 50 to display a keyword interface and defines a first and a second groups of keywords in the keyword interface in response to user inputs from the input unit 10, and stores the two groups of keywords in the storage unit 20. Each of the two groups of keywords includes a number of keywords. All the keywords in the first group of keywords are associated with topics or statements or information which a user of the mobile phone 1 wants to know about. All the keywords in the second group of keywords are associated with topics or statements or information which are of no interest to the user of the mobile phone 1 and thus wishes to delete. For example, the first group of keywords may include, but not be limited to, discounts for meals or for car services, and the like, and the second group of keywords may include, but not be limited to, requests for personal information from people who might wish to create forgeries of documents from the personal information of the user, or from people wishing to acquire from the user any legally-acquired receipts, to use for their own fraudulent purposes, and the like. In another embodiment, the two groups of keywords to be stored are default keywords.

The folder defining module 420 controls the display unit 50 to display a folder interface and defines at least one folder in the folder interface, and further defines a number of relationships between the at least one folder and the first group of keywords, and stores the relationships in the storage unit 20. In the embodiment, the folder defining module 420 creates folders which are each named according to a type of keyword, for example, defining one folder named as the “discount” folder, and that folder contains a particular keyword connected with that topic, and defining another folder named as “car service” folder, containing another particular keyword connected with that topic. When the communication unit 30 receives a short message, the short message processing module 430 acquires a sending phone number and contents of the short message. The phonebook comparing module 440 determines whether the sending phone number exists in the phonebook 21. If the phonebook comparing module 440 determines that the sending phone number is in the phonebook 21, the short message prompting module 470 generates a short message alert which prompts the user of the mobile phone 1 that the mobile phone 1 has received a short message. For example, the short message alert may be a predefined audible tone.

If the phonebook comparing module 440 determines that the sending phone number is not in the phonebook 21, the keyword comparing module 450 will recognize the contents of the short message and determine whether the contents includes one or more keywords from the first or the second group of keywords. If the keyword comparing module 450 determines that the contents do not include any keyword from the first and the second groups of keywords, or respectively includes one or more keywords from the first and the second groups of keywords, the short message prompting module 470 generates a short message alert. If the keyword comparing module 450 determines that the contents include a keyword from the second group of keywords, for example, the contents includes the “receipt” keyword from the second group of keywords, then the short message is determined to be junk, the short message deleting module 480 deletes the short message.

If the keyword comparing module 450 determines that the contents include a keyword from the first group of keywords, the folder control module 460 acquires the keyword from the contents and any relationship between the keyword and one of the at least one folder according to the relationships from the storage unit 20, recognizes the folder, and stores the short message in the folder. For example, if the short message contents include a “car service” keyword from the first group of keywords, that is, a short message including the “car service” keyword represents a short message which is desirable or of interest to the user of the mobile phone 1, the folder control module 460 stores the short message in the “car service” folder. The folder control module 460 further controls the display unit 50 to display the short messages in one folder in response to a first user input and deletes all the short messages in the folder in response to a second user input from the input unit 10. In this way, the user of the mobile phone 1 can conveniently look at and process only those short messages which are of interest to him or otherwise considered desirable.

In other embodiments, the mobile phone 1 first determines whether the contents of the short message include a keyword from the first group of keywords and then determines whether the contents of the short message include a keyword from the second group of keywords, or the mobile phone 1 first determines whether the contents of the short message include a keyword from the second group of keywords and then determines whether the contents of the short message include a keyword from the first group of keywords.

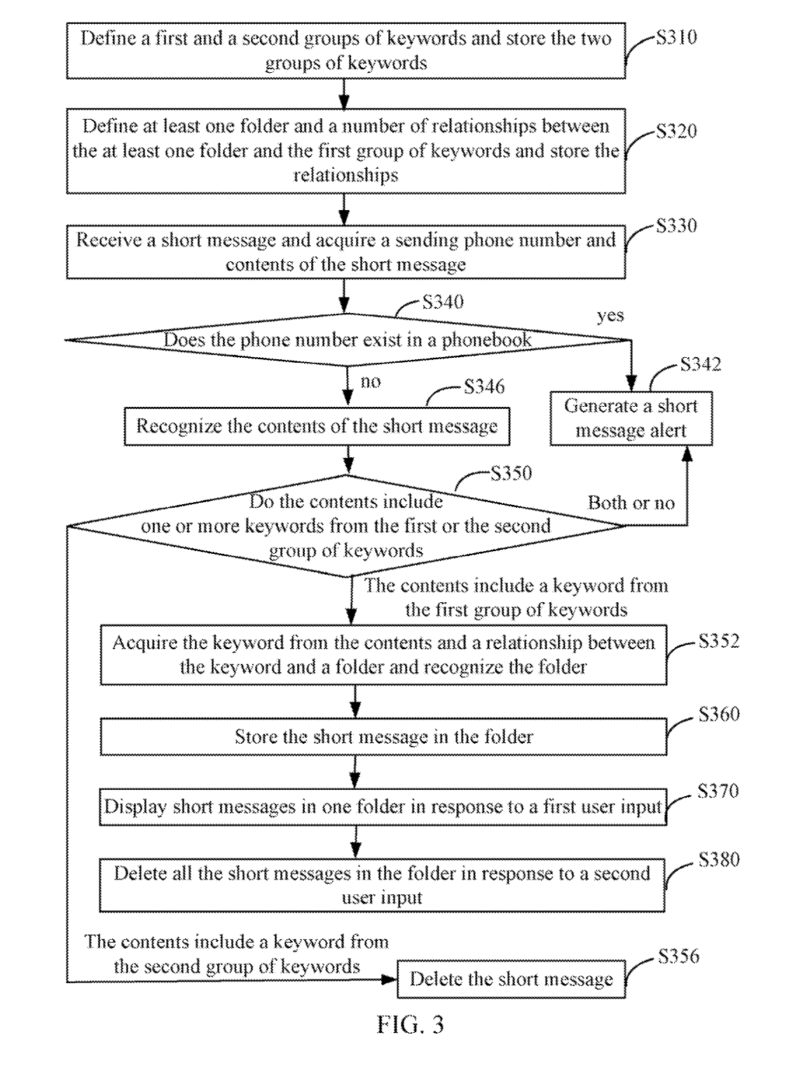

FIG. 3 is a flowchart of a method for processing short messages adapted for the mobile phone of FIG. 1. In step S310, the keyword defining module 410 controls the display unit 50 to display the keyword interface and defines the first and the second groups of keywords in the keyword interface in response to user inputs from the input unit 10, and stores the two groups of keywords in the storage unit 20. In step S320, the folder defining module 420 controls the display unit 50 to display the folder interface and defines the at least one folder in the folder interface, further defines the relationships between the at least one folder and the first group of keywords, and stores the relationships in the storage unit 20.

In step S330, when the communication unit 30 receives a short message, the short message processing module 430 acquires a sending phone number and the contents of the short message. In step S340, the phonebook comparing module 440 determines whether the sending phone number exists in the phonebook 21. If the phonebook comparing module 440 determines that the sending phone number is in the phonebook 21, in step S342, the short message prompting module 470 generates a short message alert.

In step S346, if the phonebook comparing module 440 determines that the sending phone number is not in the phonebook 21, the keyword comparing module 450 parses and recognizes the contents of the short message. In step S350, the keyword comparing module 450 determines whether the contents include one or more keywords from the first or the second group of keywords. If the keyword comparing module 450 determines that the contents do not include any such keyword, or respectively include one or more keywords from the first and the second groups of keywords, the procedure goes back to the step S342. In step S356, if the keyword comparing module 450 determines that the contents include a keyword from the second group of keywords, the short message deleting module 480 deletes the short message.

In step S352, if the keyword comparing module 450 determines that the contents include a keyword from the first group of keywords, the folder control module 460 acquires that keyword from the content of the short message and the relationship between the keyword and one of the at lease one folder according to the defined relationships from the storage unit 20, and recognizes the folder. In step S360, the folder control module 460 stores the short message in the folder. In step S370, the folder control module 460 further controls the display unit 50 to display the short messages in one folder in response to a first user input. In step S380, the folder control module 460 deletes all the short messages in the folder in response to a second user input from the input unit 10.

Therefore, when the mobile phone 1 receives a short message, the mobile phone 1 determines whether the short message is junk or useful according to the keywords predefined by the user. If the short message is junk, the mobile phone 1 directly deletes the short message. If the short message is determined to be useful or desirable, the mobile phone 1 stores the short message in a corresponding folder to later display. The processing of the desirable and useful messages only is rendered convenient for the user.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A mobile phone comprising:
an input unit;
a communication unit for receiving short messages;
a storage unit for storing a first group of keywords and a second group of keywords, at least one folder, and a plurality of relationships between the at least one folder and the first group of keywords; and
a control unit, comprising:
a short message processing module for acquiring contents of a short message when the communication unit receives the short message;
a keyword comparing module for recognizing the contents of the short message and determining whether the contents comprise one or more keywords from the first or the second group of keywords;
a short message deleting module for deleting the short message when the keyword comparing module determines that the contents comprise a keyword from the second group of keywords; and
a folder control module for acquiring the keyword from the contents and a relationship between the keyword and one of the at least one folder according to the relationships from the storage unit and storing the short message in the folder when the keyword comparing module determines that the contents comprise a keyword from the first group of keywords.

2. The mobile phone as recited in claim 1, wherein the control unit further comprises a keyword defining module for displaying a keyword interface and defining the first and the second groups of keywords in the keyword interface in response to user inputs from the input unit and storing the two groups of keywords in the storage unit.

3. The mobile phone as recited in claim 1, wherein the control unit further comprises a folder defining module for displaying a folder interface and defining the at least one folder in the folder interface, further defining the plurality of relationships between the at least one folder and the first group of keywords, and storing the relationships in the storage unit.

4. The mobile phone as recited in claim 1, wherein the storage unit further stores a phonebook, the control unit further comprises a phonebook comparing module and a short message prompting module, the phonebook comparing module is configured for determining whether the sending phone number exists in the phonebook, if the phonebook comparing module determines that the sending phone number is in the phonebook, the short message prompting module is configured for generating a short message alert, and if the phonebook comparing module determines that the sending phone number is not in the phonebook, the keyword comparing module recognizes the contents of the short message.

5. The mobile phone as recited in claim 1, wherein all the keywords in the first group of keywords are associated with topics or statements or information which a user of the mobile phone wants to know about, and all the keywords in the second group of keywords are associated with topics or statements or information which are of no interest to the user of the mobile phone and thus wishes to delete.

6. The mobile phone as recited in claim 5, wherein the first group of keywords comprises discounts for meals or for car services, and the second group of keywords comprises requests for personal information from people who might wish to create forgeries of documents from the personal information of the user, or from people wishing to acquire from the user any legally-acquired receipts, to use for their own fraudulent purposes.

7. The mobile phone as recited in claim 1, wherein the folder control module is further configured for displaying short messages in one folder in response to a first user input and deleting all the short messages in the folder in response to a second user input from the input unit.

8. The mobile phone as recited in claim 1, wherein the control unit further comprises a short message prompting module, if the keyword comparing module determines that the contents do not comprise any keyword from the first and the second groups of keywords, or respectively comprise one or more keywords from the first and the second groups of keywords, the short message prompting module is configured for generating a short message alert.

9. A processing short message method adapted for a mobile phone, wherein the mobile phone stores a first and a second groups of keywords, at least one folder, and a plurality of relationships between the at least one folder and the first group of keywords, the method comprising:
acquiring contents of a short message when the mobile phone receives the short message;
recognizing the contents of the short message and determining whether the contents comprise one or more keywords from the first or the second group of keywords;
deleting the short message if the contents comprise a keyword from the second group of keywords; and
acquiring a keyword from the contents and a stored relationship between the keyword and one of the at least one folder and storing the short message in the folder if the contents comprise the keyword from the first group of keywords.

10. The processing short message method as recited in claim 9, further comprising:
displaying a keyword interface and defining the first and the second groups of keywords in the keyword interface in response to user inputs and storing the two groups of keywords.

11. The processing short message method as recited in claim 9, further comprising:
displaying a folder interface and defining the at least one folder in the folder interface, further defining the plurality of relationships between the at least one folder and the first group of keywords, and storing the relationships.

12. The processing short message method as recited in claim 9, wherein the mobile phone further stores a phonebook, the method comprising:
determining whether the sending phone number exists in the phonebook;
generating a short message alert if the sending phone number is in the phonebook; and
recognizing the contents of the short message if the sending phone number is not in the phonebook.

13. The processing short message method as recited in claim 9, wherein all the keywords in the first group of keywords are associated with topics or statements or information which a user of the mobile phone wants to know about, and all the keywords in the second group of keywords are associated with topics or statements or information which are of no interest to the user of the mobile phone and thus wishes to delete.

14. The processing short message method as recited in claim 13, wherein the first group of keywords comprises discounts for meals or for car services, and the second group of keywords comprises requests for personal information from people who might wish to create forgeries of documents from the personal information of the user, or from people wishing to acquire from the user any legally-acquired receipts, to use for their own fraudulent purposes.

15. The processing short message method as recited in claim 9, further comprising:
displaying short messages in one folder in response to a first user input and deleting all the short messages in the folder in response to a second user input.

16. The processing short message method as recited in claim 9, further comprising:
generating a short message alert if the contents do not comprise any keyword from the first or second groups of keywords.

17. The processing short message method as recited in claim 9, further comprising:
generating a short message alert if the contents respectively comprise one or more keywords from the first and the second groups of keywords.
